(19) United States
(12) Patent Application Publication
(10) Pub. No.: US 2001/0022312 A1
(43) Pub. Date: Sep. 20, 2001

(54) LOAD CARRIER STRUT

(76) Inventor: ANDERS LUNDGREN, GRIMSAS (SE)

Correspondence Address: KILPATRICK STOCKTON LLP, 11130 SUNRISE VALLEY DRIVE, SUITE300, RESTON, VA, 20191-4329, US

(21) Appl. No.: 09/264,398

(22) Filed: Mar. 8, 1999

(30) Foreign Application Priority Data
Sep. 9, 1996 (SE) 9603276-8

(51) Int. Cl. B60R 9/04; B60R 9/05

(52) U.S. Cl. 224/309; 224/316; 224/324

(57) ABSTRACT

An arrangement for mounting upon load carrier feet that are disposed at opposing side edge regions of a vehicle roof, the arrangement including a load carrier strut that has a substantially streamlined outer cross-sectional configuration that is exteriorly defined, at least partially, by an outer contour line. Longitudinal slots are located at opposing end regions of the load carrier strut on an underside of the load carrier strut. The outer contour line of the streamlined outer cross-sectional configuration of the load carrier strut is being broken at the underside of the load carrier strut by a longitudinal projecting portion that has a forward defining surface, a rear defining surface and a bottom surface. The forward defining surface and the rear defining surface are approximately parallel and vertical. The bottom surface is substantially planar and transversely directed to the forward defining surface and the rear defining surface. Preferably, however, the bottom surface is at right angles to the forward and rear defining surfaces. The load carrier strut has a hollow interior profile that is substantially rectangular in cross sectional shape and that has a lower defining surface established by the bottom surface or wall of the projecting portion. Longitudinal countersunk portions are formed in the bottom surface of the projecting portion, one each of the longitudinal countersunk portions being located along longitudinal sides of the longitudinal slots. Further, each of the longitudinal countersunk portions is located or positioned at a higher level (more toward the interior of the load carrier strut) than a lower edge of the forward and rear defining surfaces of the projecting portion. Upwardly directed longitudinal projections are united with an inside of the streamlined profile and the upwardly directed longitudinal projections and the forward and rear defining surfaces together establishing upright rigidifying walls within the load carrier strut.

### RELATED PATENT APPLICATIONS

This is a continuation patent application of International Application Number PCT/SE97/01484, filed Sep. 5, 1997 and that designates the United States. The full disclosure of said application in its entirety is hereby expressly incorporated by reference into the present application.

### DESCRIPTION

1. Technical Field

The present invention relates to a load carrier strut for mounting on load carrier feet disposed at opposing side edge regions of a vehicle roof, the load carrier strut having a substantially streamlined outer cross-sectional configuration and, at opposing end regions, longitudinal slots on the underside of the load carrier strut.

2. Background of the Invention

There have long been basically two different types of load carrier struts, on the one hand simple tube profiles which are normally rectangular or possibly cylindrical, and , on the other hand, more complex profiles having an outer configuration which is intended to be streamlined. As a rule, this latter group of load carrier struts is manufactured by the extrusion of aluminum.

Examples of simple, tubular load carrier struts are given in DE 3 223 21 6, FIG. 2; DE 3 61 9 673, FIG. 4 and SE 9502455-0, FIG. 1. Examples of streamlined load carrier struts are given in PCT/SE88/00616, SE 9201936-3, U.S. Pat. No. 4,501,385 (FIGS. 3 and 5) and PCT/SE90/00778 (FIG. 4).

As regards securing the load carrier strut on the load carrier foot, the technique which is disclosed in PCT/SE88/00616 is normally prevalent. In this construction, use is made of a drawpiece which is accommodated interiorly in the profile and which, via a drawbar, is united to a clamping device in the load carrier foot. The drawbar extends through a slot-shaped aperture in the underside of the profile. The same technique is also applied on a large scale as far as rectangular profiles are concerned.

While the clamping or securing technique is the same, it is common that one and the same load carrier foot cannot be employed for both simple tubular profiles and more complex and streamlined profiles. Conversely, it is naturally also the case that, for example, a streamlined profile cannot be mounted on a load carrier foot which is intended for a simpler tubular profile.

In view of the above described deficiencies associated with the use of known designs for load carrier struts, the present invention has been developed to alleviate these drawbacks and provide further benefits to the user. These enhancements and benefits are described in greater detail hereinbelow with respect to several alternative embodiments of the present invention.

### DISCLOSURE OF THE INVENTION

The present invention in its several disclosed embodiments alleviates the drawbacks described above with respect to conventionally designed load carrier struts and incorporates several additionally beneficial features. The present invention has for its object to design a load carrier strut that is disclosed by way of introduction such that it may readily be mounted on a load carrier foot which is common to both the streamlined profile and a simpler, rectangular profile. The present invention also has for its object to design a load carrier strut such that it will have good load carrying capacity and considerable torsional rigidity. Finally, the present invention has for its object to realize a load carrier strut which reduces the noise which occurs because of air flowing around the load carrier strut.

The objects forming the basis of the present invention will be attained if the load carrier strut disclosed by way of introduction is characterized in that the outer contour line of the streamlined cross section of the load carrier strut on the underside of the load carrier strut is broken by a longitudinal, projection portion which has forward and rear defining surfaces and a bottom surface.

Preferably, the forward and rear defining surfaces are also approximately parallel and vertical, while the bottom surface is substantially planar and at right angles to the forward and rear defining surfaces.

In at least one embodiment, the present invention takes the form of an arrangement adapted to be mounted on load carrier feet that are disposed at opposing side edge regions of a vehicle roof, the arrangement includes a load carrier strut that has a substantially streamlined outer cross-sectional configuration that is exteriorly defined, at least partially, by an outer contour line. Longitudinal slots are located at opposing end regions of the load carrier strut on an underside of the load carrier strut. The outer contour line of the streamlined outer cross-sectional configuration of the load carrier strut is being broken at the underside of the load carrier strut by a longitudinal projecting portion that has a forward defining surface, a rear defining surface and a bottom surface.

The forward defining surface and the rear defining surface are approximately parallel and vertical. The bottom surface is substantially planar and transversely directed to the forward defining surface and the rear defining surface. Preferably, however, the bottom surface is at right angles to the forward and rear defining surfaces.

The load carrier strut has a hollow interior profile that is substantially rectangular in cross sectional shape and that has a lower defining surface established by the bottom surface or wall of the projecting portion.

Longitudinal countersunk portions are formed in the bottom surface of the projecting portion, one each of the longitudinal countersunk portions being located along longitudinal sides of the longitudinal slots. Further, each of the longitudinal countersunk portions is located or positioned at a higher level (more toward the interior of the load carrier strut) than a lower edge of the forward and rear defining surfaces of the projecting portion.

Upwardly directed longitudinal projections are united with an inside of the streamlined profile and the upwardly directed longitudinal projections and the forward and rear defining surfaces together establishing upright rigidifying walls within the load carrier strut.

The beneficial effects described above apply generally to the exemplary articles and devices disclosed herein pertaining to such a load carrier strut. The specific structures through which these benefits are delivered will be described in detail hereinbelow.

### BRIEF DESCRIPTION OF THE DRAWINGS

The present invention will now be described in greater detail hereinbelow with reference to the accompanying drawing wherein:

FIG. 1 is a schematic elevational view of a load carrier strut constructed according to an exemplary embodiment of the present invention seen from one end, together with an intimated load carrier foot.

### MODE(S) FOR CARRYING OUT THE INVENTION:

As required, detailed embodiments of the present invention are disclosed herein; however, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a basis for the claims and as a representative basis for teaching one skilled in the art to variously employ the present invention.

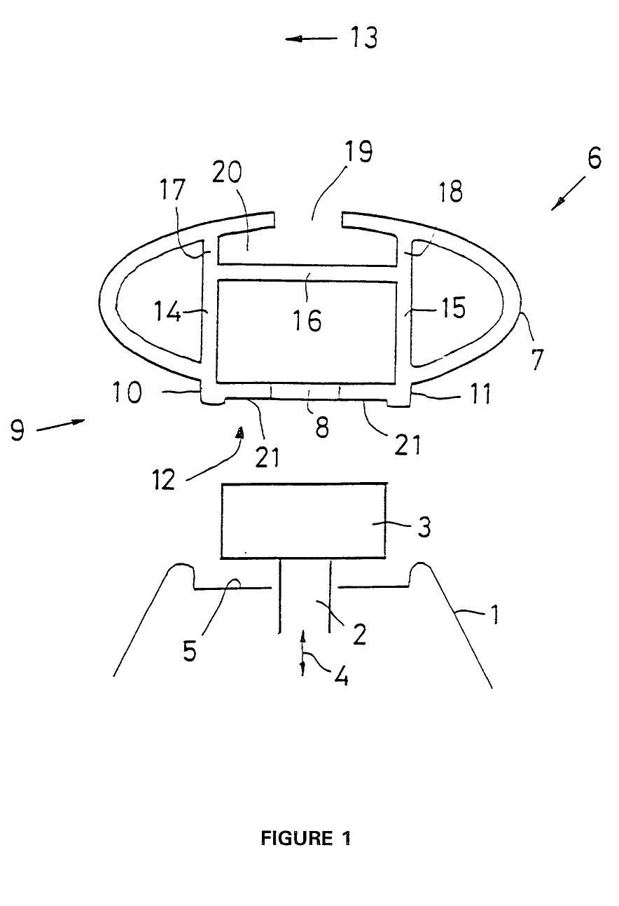

Referring to the Figures, in FIG. 1, an embodiment of the present invention is shown in which an exemplarily relationship is illustrated of a load carrier strut 6 when mounted upon a load carrier foot 1 in a position of use on a vehicle which is intended to be driven in a direction in accordance with the arrow 13. The term ‘streamlined cross section’ is to be understood to signify a generally and approximately oval, approximately elliptical or possibly droplet-shaped cross section. The concept embodied in the term ‘streamlined’ should be interpreted in a broad sense and examples of that which is encompassed in this term have been given above.

In FIG. 1, reference numeral 1 relates to a load carrier foot 1 which is intended to be secured on a side edge region of a vehicle roof, the vehicle normally being driven in the direction of the arrow 13. The detailed construction of the load carrier foot 1 is not germane to the present invention, but the load carrier foot 1 has a drawbar 2 which has a head 3 at its upper end and which is movable in accordance with the double-headed arrow 4 upwardly and downwardly under the action of a clamping or operating device. Further, the load carrier foot 1 has a support surface 5 on which the load carrier strut 6 is intended to rest. In the downwardly drawn position, the head 3 clamps the load carrier strut 6 down so that it is pressed against the support surface 5 and is positionally fixed.

The load carrier strut 6 has an outer edge line 7 which defines the streamlined cross section of the load carrier strut 6. On its underside, the load carrier strut 6 has, at its end regions, longitudinally directed grooves 8 through which the drawbar 2 extends when the load carrier strut 6 is mounted on the load carrier foot 1.

On its underside, the load carrier strut 6 has a longitudinal, projection portion 9 which, in the longitudinal direction, at least extends along the groove 8. The projecting portion 9 has forward and rear defining surfaces 10 and 11, respectively, as well as a bottom surface 12. Preferably, both the forward and rear defining surfaces are substantially vertical and parallel with one another, while the bottom surface 12 is substantially planar and is transversely directed, or at right angles to the forward and rear defining surfaces.

The projecting portion 9 may be seen as a lower portion of a rectangular tube profile which has a front wall 14, a rear wall 15, an upper wall 16 and a bottom wall 12. This tubular profile preferably has the same outer dimensions as the tubular profile with which the load carrier foot 1 is also intended to cooperate.

On the upper side of the rectangular tube profile, there are provided longitudinal and upwardly directed projections 1 7 and 1 8 which are united, preferably by being of one piece manufacture, with the inner surface of the streamlined profile. As shown in FIG. 1, the projections 17 and 18 may be made as extensions of the front wall 14 and rear wall 15, respectively, of the rectangular profile. Other placings of the projections 17 and 18 in the direction of travel 13 of the vehicle may come into consideration. In the embodiment shown in FIG. 1, however, the front and rear walls 14 and 15 of the rectangular profile form, together with the upwardly directed projections, vertical rigidifying walls interiorly in the streamlined profile, as a result of which the streamlined profile will have front and rear tubular, closed profile portions.

The streamlined profile has, on its upper side, a longitudinal groove 19 usually throughout its entire length. Interiorly in the streamlined profile and beneath the groove 19, a space 20 is established that is intended to accommodate a head similar to the head 3 of the load carrier foot 1, such a head being intended for fixedly clamping accessories on the load carrier strut 6.

In the foregoing, the bottom surface 12 of the projecting portion 9 has been described as entirely planar. If, however, the bottom surface 12 is given retracted or countersunk longitudinal portions on both sides of the slot(s) 8, at least along their length, a considerable reduction will be achieved of the noise caused by the air flow eddying about the load carrier strut 6. This noise may be characterized as a whistling sound generated by the slots 8. The retracted portions 21 may lie on a level which is somewhat higher than the lower edge lines of the forward and rear defining surfaces 10 and 11, respectively. The difference in height preferably lies in a range between 0.5 and 1.0 mm; most preferably it is approximately 0.8 mm.

Similarly, it is also possible to provide at the upper side of the streamlined profile similar countersunk or retracted portions at both sides of the groove 19.

As an alternative to the rectangular profile integrated into the illustrated streamlined profile, it is further contemplated to provide longitudinal strips or beads which project downwards in relation to the load carrier strut and which support the forward and rear defining surfaces 10 and 11, respectively. In this embodiment, the bottom surface 12 may be given a more optional configuration which, in principle, is exclusively determined by the appearance of the configuration of the head 3 of the load carrier foot 1 and possibly the configuration of the support surface 5.

As was mentioned above, the streamlined profile may be given varying appearance. For example, it need not be symmetrical about a horizontal plane of division, nor need it be symmetrical in the direction of travel 13 of the vehicle. A profile is thus conceivable which, in its forward end in the direction of travel 13, is more obtuse and rounded than in its rear end. Correspondingly, a profile is conceivable which has a more arcuate upper side than lower side, or vice versa.

The groove 19 may also be dispensed within the load carrier strut if those accessories which are to be fixed thereon are designed in a corresponding manner.

A load carrier strut 6 and associated components have been described herein above. These and other variations which will be appreciated by those skilled in the art are within the intended scope of this invention as claimed below. As previously stated, detailed embodiments of the present invention are disclosed herein; however, it is to be understood that the disclosed embodiments are merely exemplary of the invention that may be embodied in various forms.

Industrial Applicability:

The present invention finds applicability in the vehicular load carrier industries.

What is claimed and desired to be secured by letters patent is as follows:

1. An arrangement adapted to be mounted on load carrier feet that are disposed at opposing side edge regions of a vehicle roof, said arrangement comprising:
a load carrier strut having a substantially streamlined outer cross-sectional configuration defined at least partially by an outer contour line and, at opposing end regions thereof, longitudinal slots located on an underside of said load carrier strut; and
said outer contour line of said streamlined outer cross-sectional configuration being broken at said underside of said load carrier strut by a longitudinal projecting portion having a forward defining surface, a rear defining surface and a bottom surface.

2. The arrangement as recited in claim 1, further comprising:
said forward defining surface and said rear defining surface are approximately parallel and vertical; and
said bottom surface is substantially planar and transversely directed to said forward defining surface and said rear defining surface.

3. The arrangement as recited in claim 2, further comprising:
a hollow interior profile that is substantially rectangular in cross section and that has a lower defining surface established by said bottom surface of said projecting portion.

4. The arrangement as recited in claim 2, further comprising:
longitudinal countersunk portions in said bottom surface of said projecting portion, one each of said longitudinal countersunk portions being located along longitudinal sides of said longitudinal slots, each of said longitudinal countersunk portions being located at a higher level than a lower edge of said forward and rear defining surfaces of said projecting portion.

5. The arrangement as recited in claim 1, further comprising:
said forward defining surface and said rear defining surface are approximately parallel and vertical; and
said bottom surface is substantially planar and at a right angle to said forward defining surface and said rear defining surface.

6. The arrangement as recited in claim 5, further comprising:
a hollow interior profile that is substantially rectangular in cross section and that has a lower defining surface established by said bottom surface of said projecting portion.

7. The arrangement as recited in claim 5, further comprising:
longitudinal countersunk portions in said bottom surface of said projecting portion, one each of said longitudinal countersunk portions being located along longitudinal sides of said longitudinal slots, each of said longitudinal countersunk portions being located at a higher level than a lower edge of said forward and rear defining surfaces of said projecting portion.

8. The arrangement as recited in claim 1, further comprising:
a hollow interior profile that is substantially rectangular in cross section and that has a lower defining surface established by said bottom surface of said projecting portion.

9. The arrangement as recited in claim 8, further comprising:
longitudinal countersunk portions in said bottom surface of said projecting portion, one each of said longitudinal countersunk portions being located along longitudinal sides of said longitudinal slots, each of said longitudinal countersunk portions being located at a higher level than a lower edge of said forward and rear defining surfaces of said projecting portion.

10. The arrangement as recited in claim 8, wherein said hollow interior profile further comprises:
upwardly directed longitudinal projections united with an inside of said streamlined profile; and
said upwardly directed longitudinal projections and said forward and rear defining surfaces together establishing upright rigidifying walls within said load carrier strut.

11. The arrangement as recited in claim 10, further comprising:
longitudinal countersunk portions in said bottom surface of said projecting portion, one each of said longitudinal countersunk portions being located along longitudinal sides of said longitudinal slots, each of said longitudinal countersunk portions being located at a higher level than a lower edge of said forward and rear defining surfaces of said projecting portion.

12. The arrangement as recited in claim 1, further comprising:
a longitudinal countersunk portion in said bottom surface of said projecting portion along at least one side of at least one of said longitudinal slots, said longitudinal countersunk portion being located at a higher level than a lower edge of said forward and rear defining surfaces of said projecting portion.

13. The arrangement as recited in claim 1, further comprising:
longitudinal countersunk portions in said bottom surface of said projecting portion, one each of said longitudinal countersunk portions being located along longitudinal sides of said longitudinal slots, each of said longitudinal countersunk portions being located at a higher level than a lower edge of said forward and rear defining surfaces of said projecting portion.
